(19) United States
(12) Patent Application Publication
(10) Pub. No.: US 2013/0260844 A1
(43) Pub. Date: Oct. 3, 2013

(54) SERIES-CONNECTED COUPLERS FOR ACTIVE ANTENNA SYSTEMS

(71) Applicant: ANDREW LLC, Hickory, NC (US)

(72) Inventors: John S. Rucki, New Providence, NJ (US); Jonathon C. Veihl, New Lenox, IL (US); Santanu Roy, Jersey City, NJ (US); Trung Ly, Bridgewater, NJ (US)

(73) Assignee: ANDREW LLC, Hickory, NC (US)

(21) Appl. No.: 13/837,722

(22) Filed: Mar. 15, 2013

Related U.S. Application Data
(60) Provisional application No. 61/616,696, filed on Mar. 28, 2012.

(51) Int. Cl. H04M 1/02

(52) U.S. Cl. CPC H04M 1/026
USPC 455/575.7

(57) ABSTRACT

In one embodiment, an antenna system has a plurality of antenna paths and a calibration circuit. Each of the antenna paths has a transceiver and an antenna element. The calibration circuit has (i) a calibration transceiver and a different coupler coupled to each antenna path. The couplers are connected in series with one another and with the calibration transceiver. Connecting the couplers in series, rather than in parallel, reduces the amount of cabling needed and the need for a combiner/splitter or switch matrix between the couplers and the calibration transceiver, thereby reducing the cost, volume, and/or weight associated with the calibration circuit.

### CROSS-REFERENCE TO RELATED APPLICATIONS

This application claims the benefit of the filing date of U.S. provisional application No. 61/616,696, filed on Mar. 28, 2012 as attorney docket no. 1052.102PROV, the teachings of all of which are incorporated herein by reference in their entirety.

### BACKGROUND OF THE INVENTION

1. Field of the Invention

The present invention relates to radio antenna systems, and, more specifically but not exclusively, to controlling radiation and reception patterns of radio antenna systems.

2. Description of the Related Art

FIG. 1 shows a simplified block diagram of one implementation of a prior-art cellular-radio antenna system 100. In general, radio antenna system 100 is a bi-directional system that operates concurrently in both a transmit direction (i.e., downlink direction) and a receive direction (i.e., uplink direction). Radio antenna system 100 comprises a plurality of active antenna paths 116, each path 116(i) comprising a transceiver 108(i) and an antenna element 114(i) (or a subarray of antenna elements), where i=1, 2, . . . , n and n>1.

In the downlink direction, downlink digital processor 104 of digital controller 102 receives a downlink signal from a base station (not shown). Downlink digital processor 104 digitally splits the downlink signal into n copies of the downlink signal, and applies a desired TX gain Aₜᵢ and TX phase θₜᵢ to each copy. Each copy is provided to a different transceiver 108(i) that performs processing such as, but not limited to, digital processing, digital-to-analog conversion, and conversion to the radiation frequency to prepare the copy for transmission.

Each analog copy is then radiated from a corresponding antenna element 114(i) to one or more mobile receivers (not shown). The signals radiated from antenna elements 114(1)-(n) combine to form a radiation pattern in front of radio antenna system 100, and the shape of the radiation pattern is selectively controllable by controlling the TX gains Aₜᵢ and TX phases θₜᵢ of the copies of the downlink signal provided to antenna elements 114(1)-(n).

In the uplink direction, each antenna element 114(i) receives a different copy of an uplink signal from each of one or more mobile receivers (not shown) and provides each copy to a corresponding transceiver 108(i). Each transceiver 108(i) performs processing such as, but not limited to, low-noise amplification, filtering, conversion to an intermediate frequency, analog-to-digital conversion, and digital processing. Uplink digital processor 106 of digital controller 102 applies a desired RX gain Aᵣᵢ and RX phase θᵣᵢ to each digital copy of the uplink signal(s) and combines the copies to generate a single uplink signal that is provided to the base station (not shown). The copies received by antenna elements 114(1)-(n) combine to form a reception pattern, and the shape of the reception pattern is selectively controllable by controlling the RX gains Aᵣᵢ and phases θᵣᵢ of the copies received by antenna elements 114(1)-(n).

Radio antenna system 100 is typically more complex and costly to implement than comparable prior-art radio antenna systems that process the uplink and downlink signals using a single higher-powered transceiver. In such comparable radio antenna systems, the downlink signal is processed by the single transceiver having a power equal to that of transceivers 108(1)-(n) combined and split using a passive distribution network into multiple downlink copies such that the multiple downlink copies have fixed gain and phase relationships. Radio antenna system 100, on the other hand, electronically controls the gain and phase relationships on active antenna paths 116, thereby enabling more-sophisticated beam formation and beam steering features. For example, radio antenna system 100 can set or alter the beam width, beam shape, and beam direction electronically by altering the TX and RX gains Aₜᵢ and Aᵣᵢ and phases θₜᵢ and θᵣᵢ on active antenna paths 116(1)-(n).

In addition, radio antenna system 100 has a higher “availability” time due to the fact that transceivers 108(1)-(n) are redundant to one another. Thus, if one transceiver 108(i) fails, then the communications link can remain open since there are another (n−1) operational transceivers 108. The signals on the operational active antenna paths 116 can be assigned new gain and phase settings to re-optimize the beam pattern.

The signals on active antenna paths 116 in the downlink and uplink directions may have uncertain gain and phase values, especially during system power-up. Typically, transceivers 108(1)-(n) are locked to a common clock source; however, during system boot-up and channel configuration, the clocks and synthesizers on each transceiver 108(i) can settle to unknown and random absolute phases θₜᵢ and θᵣᵢ. The gains Aₜᵢ and Aᵣᵢ of the downlink and uplink signals can also be in error relative to desired values.

Therefore, radio antenna system 100 includes a calibration circuit comprising n directional couplers 112(1)-(n), radio-frequency (RF) passive combiner/splitter 120 (or RF switch matrix 122), calibration transceiver 118, and n RF cables 110(1)-(n) for monitoring and controlling the adjustment of the gains Aₜᵢ and Aᵣᵢ and phases θₜᵢ and θᵣᵢ of all active antenna paths 116. The calibration circuit performs (i) an initial calibration to alleviate any misalignments that occur during start-up and (ii) ongoing monitoring and re-adjustment to maintain the desired gains Aₜᵢ and Aᵣᵢ and phases θₜᵢ and θᵣᵢ that assure a desired beam formation.

To calibrate the downlink direction, test signals are sent in the downlink direction on active antenna paths 116(1)-(n) toward antenna elements 114(1)-(n). A portion of the power of the test signal sent on each path 116(i) is transferred via a corresponding coupler 112(i) to a corresponding cable 110(i). Combiner/splitter 120 (or switch matrix 122) sums the test signals and provides the summed test signal to calibration transceiver 118. Calibration transceiver 118 performs operations analogous to those of transceivers 108(1)-(n) and measures the test signals. Calibration transceiver 118 and/or digital controller 102 implements an algorithm to determine adjustments to the TX gains Aₜᵢ and TX phases θₜᵢ of the signals on active antenna paths 116(1)-(n) based on the measurements. Downlink digital processor 104 then adjusts the TX gains Aₜᵢ and TX phases θₜᵢ of the signals on active antenna paths 116(1)-(n) to insure that the TX gains Aₜᵢ and TX phases θₜᵢ of the signals on active antenna paths 116(1)-(n) are appropriate relative to one another for a desired TX radiation pattern to be formed.

A number of different algorithms can be used to perform the downlink calibration. For example, test signals can be sent concurrently on an initial pair of active antenna paths 116, allowing the two paths in the initial pair to be calibrated relative to each other. Then, each of the other active antenna paths 116 can be calibrated, one at a time, by pairing each other active antenna path 116 with a reference path. The reference path may be either (i) one of the originally calibrated paths, such that all other active antenna paths 116 are calibrated using the same reference path, or (ii) an active antenna path 116 that was calibrated in the previous pair, such that the reference changes from one pair to the next.

If appropriate hardware and software resources are available, then the downlink calibration process can involve concurrent transmission of test signals on more than two, and even all, active antenna paths 116. The test signal on each active antenna path 116(i) may be uniquely modulated so that, after combiner/splitter 120 sums all of the test signals, each test signal can be separated from the summation of test signals by calibration transceiver 118 or digital controller 102.

To calibrate in the uplink direction, calibration transceiver 118 sends a single test signal to combiner/splitter 120, which splits the signal into multiple copies of the test signal that are provided to cables 110(1)-(n). A portion of the power of each copy of the test signal is transferred via a coupler 112(i) to a corresponding active antenna path 116(i), where the copy is processed by a transceiver 108(i) and provided to uplink digital processor 106 of digital controller 102. Ultimately, uplink digital processor 106 receives n different versions of the test signal from active antenna paths 116(1)-(n) and alters the RX gains Aᵣᵢ and RX phases θᵣᵢ of the signals received on active antenna paths 116(1)-(n) such that a proper receive pattern is formed for the mobile-to-antenna link.

Similar to the downlink calibration, the uplink calibration can utilize different algorithms. The RX gains Aᵣᵢ and RX phases θᵣᵢ of the signals on active antenna paths 116(1)-(n) can be calibrated in pairs, such that (i) each subsequent pair includes one of the active antenna paths 116(i) in the first pair as a reference, or (ii) each subsequent pair contains an active antenna path that was calibrated in the previous pair. As another alternative, more than two, and even all, active antenna paths 116(1)-(n) can be calibrated concurrently by modulating the test carrier such that the copy on each active antenna path 116(i) can be identified uniquely by uplink digital processor 106 from the summed signal.

### SUMMARY OF THE INVENTION

In one embodiment, the present invention is an antenna system comprises first and second antenna paths and a calibration circuit. The first and second antenna paths, each comprise a transceiver and an antenna element. The calibration circuit comprises (i) a calibration transceiver, (ii) a first coupler coupled to the first antenna path, and (ii) a second coupler coupled to the second antenna path. The first coupler, the second coupler, and the calibration transceiver are connected in series

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 shows a simplified block diagram of one implementation of a prior-art cellular-radio antenna system;

FIG. 2 shows a simplified block diagram of a cellular-radio antenna system according to one embodiment of the disclosure; and

FIG. 3 shows a simplified block diagram of a cellular-radio antenna system according to another embodiment of the disclosure.

### DETAILED DESCRIPTION

Reference herein to “one embodiment” or “an embodiment” means that a particular feature, structure, or characteristic described in connection with the embodiment can be included in at least one embodiment of the invention. The appearances of the phrase “in one embodiment” in various places in the specification are not necessarily all referring to the same embodiment, nor are separate or alternative embodiments necessarily mutually exclusive of other embodiments. The same applies to the term “implementation.”

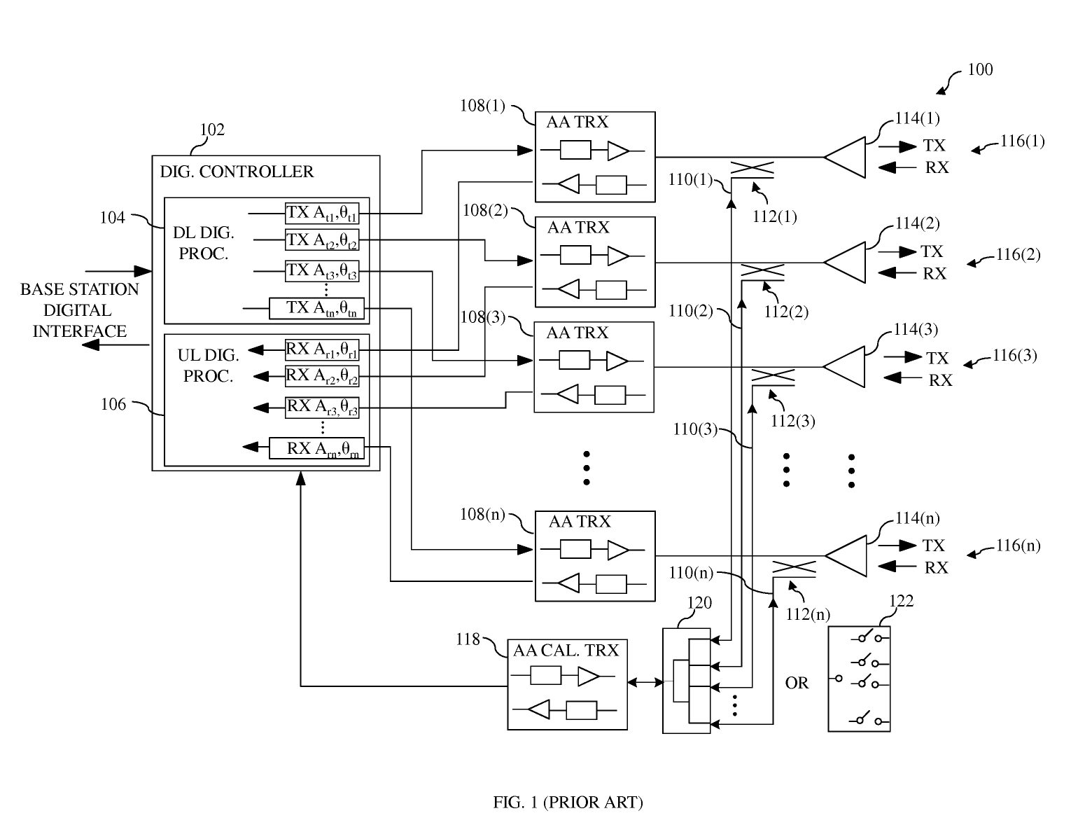

The calibration circuit of FIG. 1 includes a great deal of costly RF interconnection circuitry, namely combiner/splitter 120 (or RF switch matrix 122), directional couplers 112(1)-(n), and RF cables 110(1)-(n). Rather than implementing n RF cables 110(1)-(n) in a parallel-connected fashion such that each coupler 112(i) connects directly to combiner/splitter 120 as shown in FIG. 1, the couplers can be implemented in a series-connected fashion, such that the need for combiner/splitter 120 (or RF switch matrix 122) is eliminated.

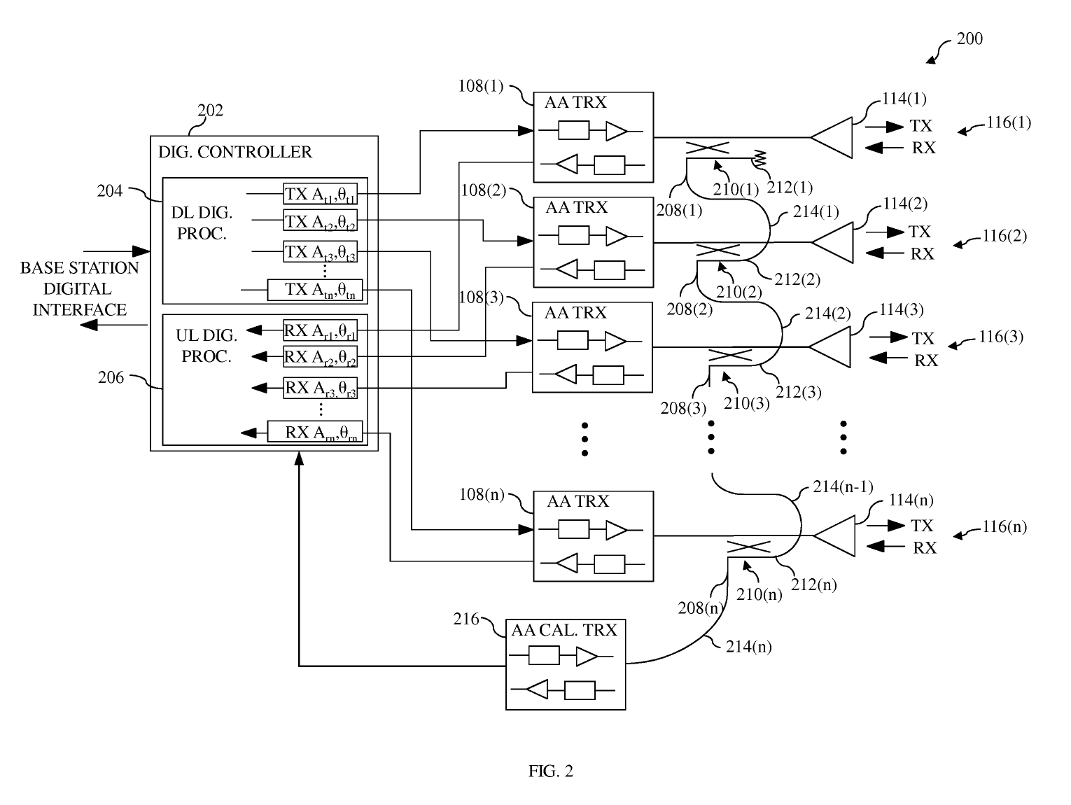

FIG. 2 shows a simplified block diagram of a cellular-radio antenna system 200 according to one embodiment of the disclosure. Radio antenna system 200 comprises digital controller 202, transceivers 108(1)-(n), and antenna elements 114(1)-(n) (or n subarrays of antenna elements) that operate in manners similar to those described relative to the analogous components in FIG. 1 to transmit signals in the downlink direction to one or more mobile receivers (not shown) and receive signals in the uplink direction from one or more mobile receivers (not shown).

Radio antenna system 200 also has a calibration circuit that comprises directional couplers 210(1)-(n), calibration transceiver 216, and RF cables 214(1)-(n) for monitoring and calibrating the TX and RX amplitudes Aₜᵢ and Aᵣᵢ and TX and RX phases θₜᵢ and θᵣᵢ of all active antenna paths 116(1)-(n). Couplers 210(1)-(n), which may be implemented using, for example, quarter wavelength type couplers, each comprise a coupled port 208(i) and an isolation port 212(i). For i=1, . . . , n−1, the coupled port 208(i) of coupler 210(i) is connected to the isolation port 212(i+1) of coupler 210(i+1), such that couplers 210(1)-(n) are connected in series. Further, the isolation port 212(1) of coupler 210(1) is terminated at a load (e.g., 50 ohms), and the coupled port 208(n) of coupler 210(n) is connected to calibration transceiver 216.

Calibration in the downlink and uplink directions is similar to that described above in relation to FIG. 1 in that active antenna paths 116(1)-(n) can be calibrated in pairs or in groups of more than two active antenna paths 116(i) at a time.

In the downlink direction, test signals are sent from downlink digital processor 204 on active antenna paths 116(1)-(n) toward antenna elements 114(1)-(n). A portion of the test signal power (e.g., about 1% of the test signal power for a 20 db coupler) sent on each active antenna path 116(i) is transferred via a corresponding coupler 210(i) to a corresponding cable 214(i). Each directional coupler 210(i) comprises a main line that is connected to a corresponding active antenna path 116(i) and a coupled line that is connected between the coupler's corresponding isolation port 212(i) and coupled port 208(i). As the test signal passes through the main line to the corresponding antenna element 116(i), power from the test signal is transferred from the main line to the coupled line in the direction of the coupled port 208(i), and is ultimately provided to the corresponding cable 214(i).

Rather than summing all of the test signals at once using a single combiner/splitter such as combiner/splitter 120 of FIG. 1 (or switch matrix 122), the test signals are sequentially and incrementally summed as they propagate down couplers 210(2)-(n) and cables 214(2)-(n). For instance, suppose that active antenna paths 116(1) and 116(2) are calibrated concurrently by sending first and second test signals on active antenna paths 116(1) and 116(2), respectively. A portion of the power of the first test signal is transferred via coupler 210(1) to cable 214(1), which is connected to isolation port 212(2) of coupler 210(2). Most of the power of that portion of the first test signal passes through the coupled line of coupler 210(2) to cable 214(2) via coupled port 208(2). In addition, a portion of power of the second test signal is transferred via coupler 210(2) to cable 214(2), which is connected to isolation port 212(3) of coupler 210(3).

As the coupled portions of the first and second test signals propagate through couplers 210(2)-(n) and cables 214(2)-(n), the signals are summed together. Note that some signal losses will occur due to, for example, coupling at couplers 210(2)-(n) from the coupling paths to the main paths and onto active antenna paths 210(2)-(n). These losses can be determined before implementing antenna system 200 and accounted for using a look-up table.

The combined test signal is then provided through couplers 210(3)-(n) to calibration transceiver 216, which performs operations analogous to calibration transceiver 118. Calibration transceiver 216 and/or digital controller 202 implements an algorithm to determine adjustments to the TX gains Aₜᵢ and TX phases θₜᵢ of the signals on active antenna paths 116(1)-(n) based on the measurements. Similar to downlink digital processor 104, downlink digital processor 204 adjusts the TX gains Aₜᵢ and TX phases θₜᵢ of the signals on active antenna paths 116(1)-(n) to insure that the TX gains Aₜᵢ and TX phases θₜᵢ of the signals on active antenna paths 116(1)-(n) are appropriate relative to one another for a desired radiation pattern to be formed.

In the uplink direction, calibration transceiver 216 sends a single test signal via cable 214(n) to coupler 210(n). Coupler 210(n) receives the test signal at its corresponding coupled port 208(n) and provides the test signal to its corresponding isolation port 212(n), less a portion of the test signal power (e.g., about 1% of the test signal power), which is transferred to the main line of the coupler 210(n) toward transceiver 108(n). For i=2, . . . , n−1, each coupler 210(i) receives a remaining portion of the test signal at a corresponding isolation port 212(i), and provides the remaining portion to the coupled port 208(i−1) of the next coupler 210(i−1), less another portion of the test signal power (e.g., about 1% of the remaining test signal power), which is transferred to the main line of the coupler 210(i) toward a corresponding transceiver 108(i).

Ultimately, uplink digital processor 206 receives n different versions of the test signal from active antenna paths 116(1)-(n) and alters the RX gains Aᵣᵢ and RX phases θᵣᵢ of the signals received on active antenna paths 116(1)-(n) such that a proper receive pattern is formed for the mobile to antenna link.

The transmit and receive algorithms employed by radio antenna system 200 may be similar to those used by cellular-radio antenna system 100 of FIG. 1; however, they may also take into account variations in the test signals due to, for example, temperature fluctuations and losses at couplers 210(1)-(n) that may occur from passing the test signals through multiple couplers 210. For instance, the algorithms may take into account the different loss and phase values of the test signals that may result when the test signals travel over different distances. In at least some embodiments, those variations may be characterized prior to implementing cellular-radio antenna system 200, and stored in look-up tables that are employed by calibration transceiver 216 and/or digital controller 202 to account for those variations when adjusting the TX and RX gains Aₜᵢ and Aᵣᵢ and TX and RX phases θₜᵢ and θᵣᵢ.

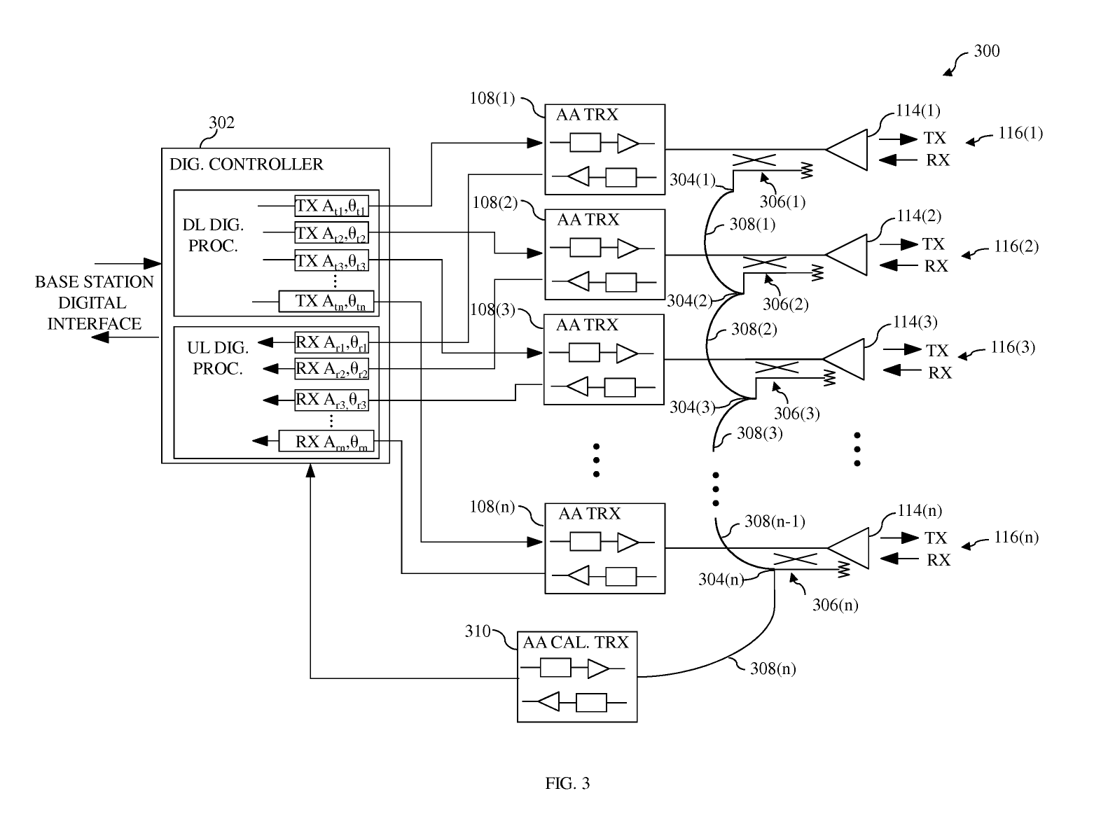

FIG. 3 shows a simplified block diagram of a cellular-radio antenna system 300 according to another embodiment of the disclosure. Radio antenna system 300 comprises digital controller 302, transceivers 108(1)-(n), and antenna elements 114(1)-(n) that operate in manners similar to those described relative to the analogous components in FIG. 1 to transmit signals in the downlink direction to one or more mobile receivers (not shown) and receive signals in the uplink direction from one or more mobile receivers (not shown).

Radio antenna system 300 also comprises couplers 306(1)-(n) and calibration transceiver 310 that are coupled in series. For i=1, . . . , n−1, the common port 304(i) of each coupler 306(i) is coupled via a corresponding cable 308(i) to the common port 304(i+1) of the subsequent coupler 306(i+1). Each coupler 306(i) may be implemented using a printed stub or any other suitable coupler structure, including those that sample RF signals off the main-line connected to the radiating elements of the coupler. Calibration of active antenna paths 116(1)-(n) in FIG. 3 is similar to that described above in relation to FIG. 2. Note that, in the uplink direction, as the test signal reaches the coupled port 304(i) of a coupler 306(i), a fraction of the test signal passes to the next coupler 306(i−1) and a remainder of the test signal is transferred via coupler 306(i) to active antenna path 116(i).

Although two embodiments of the disclosure have been described as having n couplers connected in a series fashion, embodiments of the disclosure are not so limited. Alternative embodiments of the disclosure may be envisioned in which at least two couplers are connected in series and at least two couplers are connected in parallel. In such hybrid embodiments, a combiner/splitter or switch matrix may be used between the calibration transceiver and the couplers.

In at least some embodiments, calibration circuits of the disclosure reduce the amount of cabling needed for calibration by connecting directional couplers in series, rather than in parallel. For example, in FIG. 2, the lengths of one or more of cables 214(1)-214(n−1) may be shorter than the lengths of their corresponding cables 110(i) in FIG. 1. Reducing the length of cabling reduces costs, volume, and/or weight associated with calibration circuits implemented in active antenna systems.

Further, in some embodiments (e.g., embodiments in which all of the couplers are connected in series fashion), the need for combiner/splitter 120 or switch matrix 122 in FIG. 1 is eliminated, because a single RF connection is provided to the calibration transceiver. In some other embodiments (e.g., hybrid embodiments in at least two couplers are connected series and at least two couplers are connected in parallel), the size of the combiner/splitter (or switch matrix) may be reduced over that of combiner/splitter 120 or switch matrix 122 in FIG. 1. Eliminating or reducing the size of the combiner/splitter or switch matrix reduces the costs, volume, and/or weight associated with calibration circuits implemented in active antenna systems.

Although the embodiments of the disclosure were described relative to their use in cellular-radio applications, the embodiments of the disclosure are not so limited. Calibration circuits of the disclosure may be used in wireless communications applications, other than cellular-radio applications, that employ multiple antenna elements to generate radiation and reception patterns.

Although embodiments of the disclosure were described as being implemented using four-port couplers, the present invention is not so limited. Alternative embodiments of the disclosure may be implemented using three-port couplers, or couplers having more than four ports.

Although embodiments of the disclosure were described as adjusting gains and phases of all n antenna paths, embodiments of the disclosure are not so limited. Alternative embodiments of the disclosure may adjust only the gains of the n antenna paths or only the phases of the n antenna paths. Further, alternative embodiments of the disclosure may adjust the gains and/or phases of only (n−1) antenna paths, where the antenna path that is not adjusted is used as a reference for adjusting the other (n−1) antenna paths.

As used herein, the term “transceiver” refers to devices that implement only a transmitter, devices that implement only a receiver, and devices that implement both a transmitter and a receiver.

Further, it will be understood that three elements can be connected in series even if there are intervening elements between those three elements. For instance, coupler 210(1), coupler 210(2), and calibration transceiver 216 of FIG. 2 are connected in series even though couplers 210(3)-(n) intervene between coupler 210(2) and calibration transceiver 216.

Unless explicitly stated otherwise, each numerical value and range should be interpreted as being approximate as if the word “about” or “approximately” preceded the value of the value or range.

It will be further understood that various changes in the details, materials, and arrangements of the parts which have been described and illustrated in order to explain the nature of this invention may be made by those skilled in the art without departing from the scope of the invention as expressed in the following claims.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

It should be understood that the steps of the exemplary methods set forth herein are not necessarily required to be performed in the order described, and the order of the steps of such methods should be understood to be merely exemplary. Likewise, additional steps may be included in such methods, and certain steps may be omitted or combined, in methods consistent with various embodiments of the invention.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

What is claimed is:

1. An antenna system comprising:
first and second antenna paths, each antenna path comprising a transceiver and an antenna element,
a calibration circuit comprising (i) a calibration transceiver, (ii) a first coupler coupled to the first antenna path, and (ii) a second coupler coupled to the second antenna path, wherein the first coupler, the second coupler, and the calibration transceiver are connected in series.

2. The antenna system of claim 1, wherein the calibration circuit is configured to calibrate at least one of a gain and a phase of a downlink signal in at least one of the first and second antenna paths.

3. The antenna system of claim 1, wherein:
the antenna system comprises n antenna paths, where n>2, each antenna path comprising a transceiver and an antenna element; and
the calibration circuit comprises n couplers, each coupler coupled to a different one of the n antenna paths, wherein the n couplers and the calibration transceiver are connected in series.

4. The antenna system of claim 3, wherein each intermediate coupler of the n couplers is directly connected to a single upstream coupler and a single downstream coupler.

5. The antenna system of claim 3, wherein the upstream coupler is the closest upstream coupler and downstream coupler is the closest downstream coupler.

6. The antenna system of claim 1, wherein:
each coupler comprises a coupled port and an isolation port; and
the isolation port of the first coupler is connected to the coupled port of the second coupler.

7. The antenna system of claim 6, wherein each coupler is a quarter-wavelength coupler.

8. The antenna system of claim 1, wherein:
each coupler comprises a coupled port; and
the coupled port of the first coupler is connected to the coupled port of the second coupler.

9. The antenna system of claim 8, wherein each coupler is a stub-type coupler.

10. The antenna system of claim 1, wherein the calibration circuit is implemented without a combiner/splitter or a switch network between (i) the first and second couplers and (ii) the calibration transceiver.

11. The antenna system of claim 1, wherein the calibration transceiver is directly connected to only one coupler.

12. The antenna system of claim 1, wherein:
the transceivers in the first and second antenna paths are configured to provide first and second downlink test signals, respectively, toward their respective antenna elements;
the first coupler is configured to pass (i) the first downlink test signal to the antenna element in the first antenna path, less a portion of the power of the first downlink test signal, and (ii) the portion of the power of the first downlink test signal to the second coupler; and
the second coupler is configured to pass (i) the second downlink test signal to the antenna element in the second antenna path, less a portion of the power of the second downlink test signal, (ii) the portion of the power of the second downlink test signal to the calibration transceiver, and (iii) the portion of the power of the first downlink test signal to the calibration transceiver.

13. The antenna system of claim 12, further comprising a downlink processor connected to the calibration transceiver and configured to adjust at least one of a gain and a phase of a downlink signal in at least one of the first and second antenna paths.

14. The antenna system of claim 13, wherein the downlink processor is configured to adjust the gain and the phase of the downlink signal in at least one of the first and second antenna paths.

15. The antenna system of claim 1, wherein:
the calibration transceiver is configured to provide an uplink test signal to the second coupler;
the second coupler is configured to pass (i) the uplink test signal to the first coupler, less a first portion of the power of the uplink test signal, and (ii) the first portion of the power of the uplink test signal to the transceiver in the second antenna path; and
the first coupler is configured to pass a second portion of the uplink test signal to the transceiver in the first antenna path.

16. The antenna system of claim 15, further comprising an uplink processor connected to the transceivers in the first and second antenna paths and configured to adjust at least one of a gain and a phase of an uplink signal in at least one of the first and second antenna paths.

17. The antenna system of claim 16, wherein the uplink processor is configured to adjust the gain and the phase of the uplink signal in at least one of the first and second antenna paths.

18. The antenna system of claim 1, wherein the antenna system is a cellular antenna system.
